(19) United States
(12) Patent Application Publication
(10) Pub. No.: US 2008/0256255 A1
(43) Pub. Date: Oct. 16, 2008

(54) PROCESS FOR STREAMING MEDIA DATA IN A PEER-TO-PEER NETWORK

(75) Inventors: Yuri Mordovskoi, Santa Monica, CA (US); Miller Nguyen, Santa Monica, CA (US); Darren Berkovitz, Bell Canyon, CA (US)

Correspondence Address: KELLY LOWRY & KELLEY, LLP, 6320 CANOGA AVENUE, SUITE 1650, WOODLAND HILLS, CA, 91367, US

(73) Assignee: METRO ENTERPRISES, INC., Beverly Hills, CA (US)

(21) Appl. No.: 12/061,275

(22) Filed: Apr. 2, 2008

Related U.S. Application Data
(60) Provisional application No. 60/911,232, filed on Apr. 11, 2007.

(51) Int. Cl. G06F 15/16

(52) U.S. Cl. 709/231

(57) ABSTRACT

The process for streaming media data in a peer-to-peer (P2P) network includes the step of submitting a request through the P2P network to play a time segment of a media file. A local computer is connected through the P2P network to a streaming computer having the desired time segment. Thereafter, an initial data byte is located in the time segment via a conversion table associated with the media file. The time segment is streamed from the streaming computer to the local computer starting with the initial data byte. The time segment is stored on the local computer for playback through a corresponding media player.

### BACKGROUND OF THE INVENTION

The present invention is generally directed to video streaming technology. More particularly, the present invention relates to the integration of peer-to-peer architecture to stream high quality video technology.

There are two main technologies that deliver internet-based multi-media content from a source provider to an end-user: (1) progressive download and (2) streaming. For progressive download, a media file is downloaded over a wide area network or downloaded through the Internet. Progressive download works with various internet connections including dial-up, DSL, ADSL, cable, Ti, or other high speed internet connections. Progressive download begins by downloading bytes at the beginning of a file and continues downloading the file sequentially until the last byte. The entire file and even parts of the file are not immediately available for playback. In some situations, the entire file must be downloaded first before a media player can start playback. In other situations, media players are able to start playback once enough of the beginning of the file has downloaded. This can be several megabytes and playback is limited to the beginning of the file. Hence, the corresponding media player requires that the computer system download enough information to support some form of playback, which is often choppy and contains a high likelihood of stopping after only a few seconds. Downloaded material is thereafter stored on the end-user computer.

Progressive download is one technique used to play media, but is not specifically designed to be played by the end-user until the entire file is received. Stoppage often occurs if playback begins before the entire file is received to allow the computer system to continue downloading the required information. Media players not equipped to playback partially downloaded files must wait for the entire file to download before playback is initiated. Long wait times accompany progressive download as large files and slow internet connections cause significant delays. Basically, progressive downloading requires that the entire file be downloaded before the media player can deliver uninterrupted playback, especially for high quality media files. Alternatively, progressive download enables playback of media files that would otherwise be too large, in terms of data rate exchange, for variable bandwidths and streaming technology.

Streaming delivers media content continuously to a media player and media playback occurs simultaneously. The end-user is capable of playing the media immediately upon delivery by the content provider. Traditional streaming techniques originated from a single provider delivering a stream of data to a set of end-users. Extremely high bandwidths and CPU power are required to deliver a single stream to a large audience. The required bandwidth of the provider increases as the number of end-users increases. The main advantage of streaming media, over progressive download, is that media is delivered on demand or live. Wherein progressive download requires downloading the entire file or downloading enough of the entire file to start playback at the beginning, streaming enables immediate playback at any point within the file. End-users may skip through the media file to start playback or change playback to any point in the media file. Hence, the end-user does not need to wait for the file to progressively download. In each of the previous streaming examples, media is typically delivered from a few dedicated servers having high bandwidth capabilities. Such capabilities are expensive and especially cost inhibitive for the providers.

To relieve the bandwidth necessities, peer-to-peer (P2P) computer networks were designed such that all peers within the network share media files among one another, rather than designating a relatively low number of sources download servers. P2P networks typically make direct ad hoc connections among peers. Under the P2P network structure, the notion of clients and servers is minimized. Equal peers across the P2P network act simultaneously as both “clients” and as “servers” to other peers, or nodes, within the P2P network. Under the traditional client-server model, as in progressive download and traditional streaming, a few content providers delivering the media files function solely as “servers” while the end-user downloading the media content functions solely as the “client”. All clients connect directly to the content providing servers. Hence, the high bandwidth requirements of the few dedicated servers.

An important aspect of the P2P network is that all peers share resources, including bandwidth. The total network capacity for exchanging media is increased with the number of peers. Simultaneously acting as both “client” and “server” increases the quantity of download channels and overall bandwidth in the network regardless of the end-user connection speed. This result is the opposite the traditional client-server model. As more clients connect to the server, less resources are available for each connected client. Dedicated servers have limited bandwidth which becomes more congested as more clients directly connect to the servers to download media content. In turn, end-users receive media at lower transfer rates as the entire bandwidth channel is split and shared among thousands of users. The P2P network is more robust than the traditional client-server model.

Data within the P2P network is replicated over multiple peers. Each peer is capable of acting as an independent server. This means that data is available from many sources, rather than a limited number of servers having a fixed bandwidth. Thus, data distribution is decentralized among peers. Traditional P2P networks are byte based and transfer data nonsequentially. Parts or chunks of the media file are transferred to client computers in a different order than playback. Traditional P2P networks such as BitTorrent, Kazza, and Gnutella utilize this data transfer method to increase efficiency of the P2P network. Accordingly, the entire media file must be downloaded and the data arranged sequentially before playback is possible.

Additionally, peers to the P2P network are located in thousands of communities worldwide. Peers experience faster download rates as connections to other local “servers” are more efficient than connecting to remote, single servers, halfway across the globe. In addition to efficiency, P2P networks do not have a single point of failure.

Data transferred over a network requires that the client and server be able to communicate across a common protocol. The Transmission Control Protocol (TCP) is a core protocol for transferring data across the Internet where networked nodes can create connections with one another and exchange streams of data using stream sockets. The User Datagram Protocol (UDP) is another protocol for transferring data across the Internet. UDP is more typically used to transfer data pertaining to video, Voice over Internet Protocol (VoIP), and streaming technology. TCP provides reliable and orderly delivery of data to and from the server and client. TCP is typically slower than UDP because TCP has a series of error correction utilities, including timeouts and retries, to guarantee correct delivery of each byte within the data stream. Unlike TCP, UDP data packets are liable to be lost or corrupted in transit. Depending upon the protocol and the extent of data packet loss, the client may recover the data with error correction or interpolation techniques that fill in missing data. Without error correction, clients may suffer dropouts and lost connections.

Reliable UDP (RUDP) is another transfer protocol in addition to UDP and TCP. RUDP is based on UDP and includes a series of additional transmission enhancements similar to TCP. These enhancements include congestion control tuning improvements, retransmission of lost or unreceived packets, and thinning server algorithms. The retransmission and congestion control algorithms provide a mechanism to stream data with reliability rates closer to that of the TCP-based error correction methods. These improvements also increase performance by utilizing available bandwidth.

Real-Time Streaming Protocol (RTSP), Real-Time Transport Protocol (RTP) and Real-Time Transport Control Protocol (RTCP) were specifically designed to stream media over networks. The RTP and RTCP protocols are independent from UDP, but can use UDP, RUDP, TCP, or hyper text transfer protocol (HTTP) to transfer data. Alternatively, Real-Time Messaging Protocol (RTMP) could be used for streaming audio, video and data over the Internet between a flash player and a server.

P2P networks have recently been integrated with streaming technology to alleviate the bandwidth constraints of dedicated servers and increased end-users. Data is exchanged through not only a dedicated server, but also through the peers to the P2P network. Peers to the P2P network retrieve data from the dedicated server or series of dedicated servers, and from peers acting as “servers”. Various models of hybrid streaming and P2P networks have been proposed such as a tree-based multicast system and a split-stream multicast system. Each system is discussed in turn below.

One design of a hybrid P2P streaming system is the tree-based multicast system. This system is based on a single tree. Data is distributed directly from a source server to a set of primary peers in the network. The number of primary peers that connect directly to the source server is limited. These primary peers, in turn, act simultaneously as servers and allow secondary peers to connect and download information received by the primary peer from the source server. The secondary peers are initially only clients within the P2P tree-based multicast system. But, once another set of clients, in this case tertiary peers, request a connection from the secondary peers, the secondary peers become simultaneous clients (streaming from the primary peers) and servers (streaming information to the tertiary peers). This pattern of peer branching continues through multiple levels of peers. The major problem with the tree-based multicast system is that if one of the peers drops out or fails to continue forwarding information, the rest of the dependent branch no longer receives data in the stream. The closer the dropout peer is to the primary server, the more dependent peers within the branch are affected. Disconnected peers are sent scrambling to find new connections. All the while the streaming media experienced by the end-user stops until new connections are formed. Thereafter streaming may resume. Additionally, the tree-based multicast system becomes unbalanced as the number of branches increases. The data bandwidth required at the bottom of the tree is relatively large compared to the top of the tree and increases significantly with the number of users. Thus, high quality media playback is not possible due to network capacity limitations.

The split-stream multicast system was developed to balance the loads on peers at the bottom of the tree-based multicast system. The split-stream multicast system splits the data stream into multiple strips that are used by separate multicast trees. In this design, the stream is split among a majority of the peers on the interior nodes of the tree. Thus, if one node unexpectedly drops out, all nodes connected to that branch are not automatically disconnected. Other nodes connected to the disconnected node have alternative streams from which to download information. The split-stream multicast system is particularly useful when a large number of cooperative peers are interested in streaming the same content. Additionally, under the split-stream multicast system peers acting as servers can control the number of client peers and control outbound bandwidths. Thus, the split-stream multicast system accommodates peers with different bandwidths and solves the traditional streaming problems under the tree-based multicast system. The major drawback to the split-stream multicast system is that branches are not optimized among peers. Clients may connect to multiple servers to ensure that the connection is not completely lost, unlike the tree-based multicast system, but clients may connect to several inefficient servers based on location, CPU, bandwidth, etc. This drawback exists even if the P2P network has sufficient capacity and ample nodes.

Accordingly, there is a need for a P2P network that incorporates streaming technology that can deliver high quality media to an end-user. Such P2P streaming technology should utilize the P2P network to moderate bandwidth requirements of the distributing server, instantly deliver high quality and high definition data to an end-user, manage a buffer zone to prevent stoppage or playback delay, include a centralized server to manage data within the P2P network, include a server to manage the efficiency of peer connections within the P2P network, and provide protection from the introduction of pirated or otherwise copyright infringed material to the P2P network. The present invention fulfills these needs and provides further related advantages.

### SUMMARY OF THE INVENTION

The present invention relates to a process for streaming media data in a peer-to-peer (P2P) network. The process begins by submitting a request through the P2P network to play a time segment of a media file. A central server may maintain a real-time catalog of the media files and the corresponding time segments stored on the computers connected to the P2P network to process this request. The central server could regulate and optimize data transfer by monitoring upload capability, download capability, data transfer efficiency, distance, latency, IP address, physical location or transfer statistics of the computers connected to the P2P network in order to efficiently connect a local computer through the P2P network to a streaming computer having the requested time segment.

Once the local computer is connected to the streaming computer, an initial data byte in the time segment is located via a conversion table associated with the media file. The conversion table appropriately includes a data byte-to-time segment conversion and a time segment-to-data byte conversion. This conversion table enables the streaming computer to immediately send the initial data byte to the local computer for immediate playback. Accordingly, the time segment is streamed from the streaming computer to the local computer starting with the initial data byte. The time segment transferred comprises a portion of the media file. The data streamed through the P2P network is compressed and decompressed to increase the transfer rate of information through the P2P network. Preferably, the P2P network transfers data by a transmission control protocol, a user datagram protocol, a reliable user datagram protocol, a real-time transfer protocol, a real-time streaming protocol or a hypertext transfer protocol. The transferred time segment is then stored on the local computer for playback through a media player.

The time segment is written to an audio/video file on the local computer. The audio/video file comprises a track file having a track audio file and a track video file and a hint track file having a hint track audio file and a hint track video file. The conversion table is stored in the hint track file and is accessed by the local browser during streaming or playback. The transfer of the media file may further be buffered by storing subsequent time segments on the local computer in the audio/video file. These additional time segments are transferred in anticipation of user playback. A faster transfer speed of the local computer corresponds to a larger buffer of time segments stored thereon.

The requested time segment may be changed by rewinding, skipping or fast forwarding through the media file. Hence, it is possible that, during the storing step, non-sequential time segments of the media file are transferred and stored on the local computer. The media player is designed to playback the media file starting with the initial data byte corresponding to the requested time segment. Of course, the initial data byte changes with each time segment. Rewinding, skipping or fast forwarding through the media file changes the requested time segment and the initial data byte accessed by the media player for playback.

The media file may also include metadata capable of having advertisements or comments written therein. The comments and advertisements may be conveyed to the user during playback. Furthermore, the metadata may include information for substituting products, people or languages with other products, people or languages during playback of the media file.

New media files are preferably introduced to the P2P network by a system administrator who manages and regulates the P2P network via a central server. Accordingly, digital rights management technology will be built into the P2P network to prevent unauthorized introduction of any new media file.

Other features and advantages of the present invention will become apparent from the following more detailed description, when taken in conjunction with the accompanying drawing, which illustrates, by way of example, the principles of the invention.

### BRIEF DESCRIPTION OF THE DRAWINGS

The accompanying drawing illustrates the invention. In such drawing:

FIG. 1 illustrates the peer-to-peer architecture technology for streaming video media.

### DETAILED DESCRIPTION OF THE PREFERRED EMBODIMENT

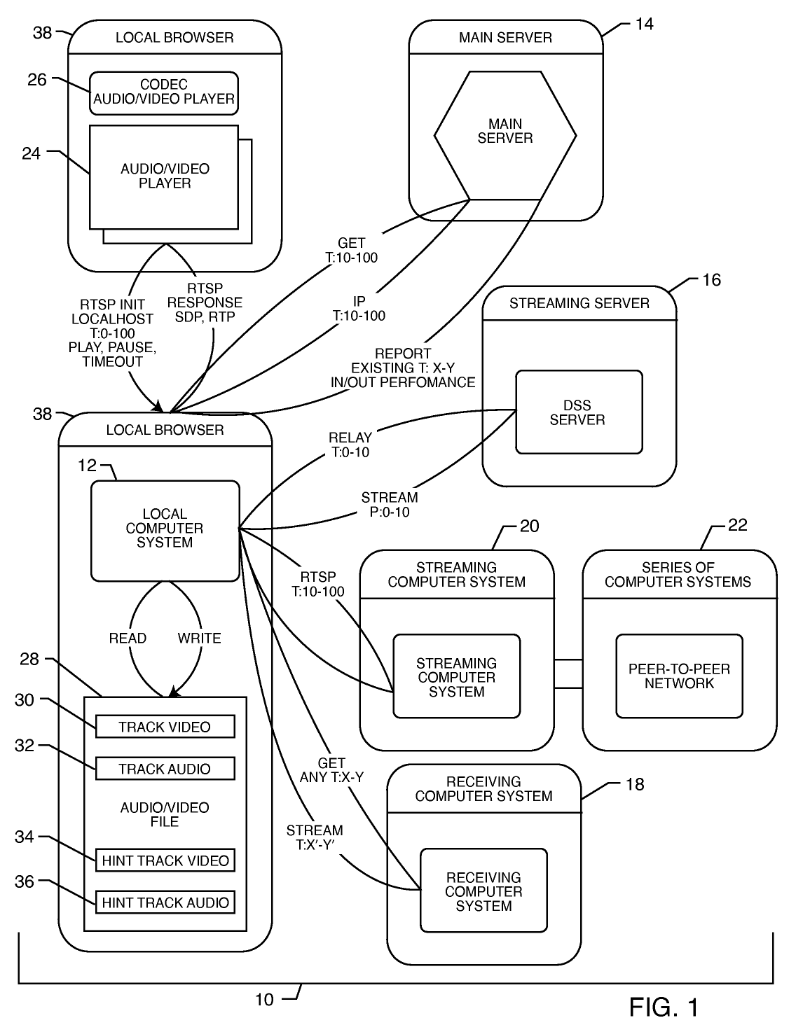

As shown in the exemplary drawing for purposes of illustration, the present disclosure of a peer-to-peer (P2P) architecture technology for streaming video media is referred to generally by the reference numeral 10. Turning now to the representative FIGURE in the specification, FIG. 1 illustrates the P2P architecture technology for streaming video media 10 including a local computer system 12, a main server 14, a streaming server 16, a receiving computer system 18, a streaming computer system 20, and a series of computer systems 22 interconnected via the P2P network. The P2P network of the present invention is designed to stream high definition, DVD quality, or otherwise high quality video and audio media to an end-user peer. It is preferred that the P2P network of the present invention use the RTSP protocol. But, the P2P network of the present invention could also use RTMP or any other general streaming audio, video or data protocols. Information transfer therefore uses time based traditional streaming technology, not byte based progressive download technology. Media files are stored, exchanged, played, and downloaded in time segments based on the duration of the file. The conversion between time and bytes within the file is stored as a hint track inside the RTSP and streaming server logic. For the purposes of the present invention, “byte” includes both a specific binary digit (i.e. a bit) or any arrangement of bits (or multiples thereof, including bytes, kilobytes, megabytes, etc.) that may be arranged or organized into, for example, a packet. For example, an initial data byte to be streamed may be either a specific bit or a data packet. This hint track, as explained in more detail below, is used to determine the exact location (i.e., the exact byte) within the media file to download or start media playback. Data is transferred between the “server” and “peer” via the RTP protocol after ad hoc peer connections are made via the RTSP protocol. But, the present invention could include any streaming audio, video or data protocol to transfer data between the server and peer.

The main server 14 serves as the data management center for all the information within the P2P architecture 10. By querying each local computer within the P2P network, information such as upload capability, download capability, data transfer efficiency, distance, latency, IP address and location, or any other electronic information known in the art is collected by the main server 14. The main server 14 can then regulate the data transfer among the local computer system 12, the receiving computer system 18, the streaming computer system 20, and any of the series of computer systems 22. The main server 14 uses the above information concerning all the computer systems within the P2P architecture 10 to efficiently route and interconnect the peers. The main server 14 also retains a log of information concerning download history, including time segments of file downloads stored as buffer, to efficiently interconnect peers that desire to playback a particular time segment of a media file. For example, when a peer endeavors to playback a media file at time “X”, the local computer system 12 contacts the main server 14 for information concerning which peers within the P2P network have already downloaded and are ready to stream the time segments pertaining to the time “X” within the media file. The main server 14 retains and continually updates a comprehensive list of information regarding media file information distributed within the series of computer systems 22 within the P2P network. Alternatively, the peer computer may retain such a list and contact the series of computer systems 22 directly. The main server 14 immediately directs the local computer system 12 to the fastest and most efficient peers while maintaining optimal global performance of the P2P network. The connections are not necessarily optimal to one node or peer, but rather optimal to the entire P2P network.

Media is introduced into the P2P architecture 10 via the streaming server 16. Unlike traditional P2P networks, the preferred embodiment of the present invention does not allow the introduction of new material via the local computer system 12, the streaming computer system 20, the receiving computer system 18, or any of the series of computer systems 22. But, alternative embodiments of the present invention could allow for the introduction of new material via any of the computer systems 12, 18, 20, 22. The administrator of the P2P architecture 10 can regulate and monitor content stored and exchanged within the P2P architecture 10. Thus, the present invention is capable of preventing the unauthorized copying and illegal distribution or introduction of copyrighted material into the P2P network. Furthermore, the streaming server 16 is also used as a backup server to store and stream less accessed media files.

The P2P network of the present invention preserves copyright protection through the implementation of Digital Rights Management (DRM). DRM controls the distribution and copying of copyrighted work within the P2P network. The first level of DRM security is that the P2P network is a closed system. Peers are not able to introduce new media themselves. All new media is introduced through the streaming server 16 only after all necessary licenses are obtained to legally distribute the media in the P2P network. A second key aspect to DRM copyright protection is that only partial files are downloaded by the peers. The entire media file is not typically stored on the local computer system 12 and therefore cannot be copied in its entirety to another location for illegal distribution. In an alternative embodiment, a third party DRM incorporated into the local computer system 12 may enable users to download entire media files for later use external to the local computer system 12, such as with a compact disc (CD), digital versatile disc (DVD) or other external media device such as an MP3 or MPEG player.

Each local computer system 12 installs an audio/video player 24 incorporating a corresponding CODEC 26. The term CODEC is typically associated as shortened acronym of a program that performs COmpression/DECompression algorithms. CODECs are integrated into media players to encode and decode media data for viewing and listening. CODECs are used in a wide variety of media applications including streaming video and audio media. The audio/video player 24 could include QuickTime, RealPlayer, Flash, Windows Media Player or any other media player known in the art capable of playing streaming media.

The audio/video player 24 and the CODEC 26 are synced with the local computer system 12 to process audio and video data stored in an audio/video file 28. The audio/video file 28 is broken into two sections including a track video 30 and a track audio 32 having corresponding hint tracks, a hint track video 34 and a hint track audio 36, respectively. It should be noted that the hint track may be called something else in other streaming data protocols. The local computer system 12 receives media data streamed from the streaming server 16, the streaming computer system 20, or any other of the series of computer systems 22. When the local computer system 12 requests to view a media file at a certain time segment, only those peers containing media file information at that time segment are connected to the local computer system 12. Connected peers then stream information directly to the local computer system 12. The media data is thereafter stored in the audio/video file 28. The local computer system 12 reads and writes information to and from the audio/video file 28. The local computer system 12 processes media data information stored in the track video 30 and the track audio 32 within the audio/video file 28 for immediate playback by the audio/video player 24 after decompression by the CODEC 26. Audio and video media data stored within a local browser 38 as part of a managed buffer is also stored in the audio/video file 28.

The hint track video 34 and the hint track audio 36 are hint tracks within the track video 30 and the track audio 32, respectively. The hint track video 34 and the hint track audio 36 contain exact time to byte conversions and vice versa. For example, if a user endeavors to playback a certain segment of a media file already completely downloaded, such as 30 seconds through a 60 second media clip, the audio/video player 24 accesses the local browser 38 and requests data pertaining to the 30 second point in the media file. The local computer system 12 processes this request by reading the hint track video 34 and hint track audio 36 in order to locate the appropriate byte within the corresponding track video 30 and track audio 32 to start playback at time=30 seconds. The local computer system 12 does not need to search through the track video 30 or the track audio 32. Playback is therefore immediate. Buffering time is also significantly reduced. The time to byte conversion stored within the hint track video 34 and the hint track audio 36 is also applicable to the transfer of data. The local computer system 12 can immediately access the exact byte within the audio/video file 28 to send to any peer within the P2P network. Again, buffering delays are significantly reduced and data download occurs almost immediately.

Initial distribution of a media file within the P2P architecture 10 comes from the streaming server 16. The streaming server 16 introduces media files into the P2P architecture 10 of the present invention based on time, rather than file size. Alternatively, progressive download has always identified and transferred media files based on file size, or bytes. For example, suppose a client wants to download a 10 megabyte (MB) media file to the local computer system 12. Progressive download starts downloading the first byte of the media file and continues downloading bytes sequentially to the last of the 10 MB. A download manager tracks the progress of the download on the basis of the number of bytes downloaded. The download manager then converts the bytes to time for playback through the media player. In terms of media content, some media players will playback content once enough of the file is downloaded. But, playback is limited to the beginning of the media file (or up to the amount downloaded). An end-user could not skip from the beginning of the media to the middle of the media file until all portions of the media file up to the middle had been downloaded. The end-user must wait for the file to download media file information up to the desired viewing point before viewing is possible. If the media file is 10 MB, the end-user would have to wait until approximately 5 MB were downloaded before even being able to view the middle of the media file. With a dial up connection speed of 56 k, downloading 5 MB can take 20 minutes or longer. Even after the file reaches 5 MB, playback is certain to be choppy as continued download will be slow. The remainder of the media file must be downloaded before smooth playback is possible.

Streaming enables end-users to skip through the media file without first downloading all of the file data. But, traditional streaming has problems meeting speed and time requirements of high quality feeds as client to server connections increase. Traditional streaming (RTSP) has more overhead and bandwidth requirements than P2P networks because media is distributed to thousands of clients via data streams that originate from relatively few source servers. In the P2P network, the streaming server 16, the streaming computer system 20, and any of the corresponding series of computer systems 22 acting as the streaming computer system 20, decentralize the transfer of the media file from a single server to multiple peer servers. The streaming server 16 and any of the streaming computer systems 20 must correlate time to bytes before streaming media data to the local computer system 12. Without the hint track video 34 and the hint track audio 36, the local computer system 12 must organize and assemble the media data after download, which prevents immediate and fast streaming playback.

The audio/video player 24 of the present invention allows the end-user to select a desired time segment within the media file to start playback. The local computer system 12 communicates with the streaming server 16 or the streaming computer systems 20 to request specific media data information pertaining to the desired playback location. The buffering time between when the user moves to a different section of the audio/video file 28 is decreased as the streaming computers instantaneously locate the specific bytes to send to the local computer system 12 via the time to byte conversion table in the hint track video 34 and the hint track audio 36. The local computer system 12 does not need to sort or assemble the media data information before playback is possible. Streaming media data based on time segments enables immediate playback with minimal buffering and time delays.

The following example further illustrates the P2P architecture 10 of the present invention. Consider again that an end-user decides to start playback halfway through a 60 second media file (30 seconds) totaling 10 MB. The local computer system 12 sends the stream request to the main server 14 based on time—here 30 seconds. The main server 14 returns a list of the most efficient streaming computer systems, which may or may not include the streaming server 16, containing media data information at the 30 second time segment within the media file. The local computer system 12 thereafter connects to those streaming computer systems and requests the media data information associated with the 30 second time segment. The streaming computer systems 20 immediately locate the specific byte to stream to the local computer system 12 by utilizing the conversion table stored in the hint tracks (i.e., the hint track video 34 and the hint track audio 36). The information stored in the streaming server 16, the streaming computer system 20, and any of the series of computer systems 22 then streams bytes of media data associated with the 30 second time segment in the media file to the local computer system 12. Streaming and playback only occurs after the hint track video 34 and the hint track audio 36 are downloaded into the audio/video file 28 of the local computer system 12. The local computer system 12 thereafter stores the media information in bytes in the audio/video file 28 as the track video 30 and the track audio 32. The hint track video 34 and the hint track audio 36 correlate the bytes in the track video 30 and the track audio 32, respectively, to the playback time—here 30 seconds. Playback then occurs as previously described.

After playback starts, the local computer system 12 begins downloading a buffer to ensure uninterrupted playback by storing media data within the track video 30 and the track audio 32. Only information viewed through the audio/video player 24 and corresponding information stored in the buffer of the track video 30 and the track audio 32 is available for streaming by the local computer system 12. As the local computer system 12 continues to retain more media data information, the receiving computer system 18 may eventually connect to the local computer system 12 to request a data stream from the local computer system 12. In this instance, the local computer system 12 would perform two functions: (1) streaming from the streaming server 16, and (2) streaming to the receiving computer system 18. Thus, the resources of the streaming server 16 are, in the two computer example, reduced by approximately one-half. Approximately half of the stream is contributed by the local computer system 12 and the other half by the streaming server 16. Once the receiving computer system 18 downloads enough media data information from the local computer system 12, any one of the series of computer systems 22 can then instantaneously interconnect with the receiving computer system 18 and the local computer system 12 to continue distribution of the media file originally released by the streaming server 16. The P2P architecture 10 effectively eliminates problems associated with progressive download and traditional streaming such that there is less bandwidth usage involved with the main server 14 and the streaming server 16. The main server 14, as previously discussed, collects data from the local computer system 12, the receiving computer system 18, the streaming computer system 20, and the series of computer systems 22 to efficiently distribute data among the computer systems within the P2P network. Such information may include upload capability, download capability, data transfer efficiency, distance, latency, IP address, physical location or transfer statistics of the plurality of computer systems 12, 18, 20, 22 connected to the P2P network.

As in the previous example, the local computer system 12 downloads information in bytes specific to a time segment within a media file. Content is viewed through the audio/video player 24 and stored in the track video 30 and the hint track audio 32 as part of the buffer in the audio/video file 28. The receiving computer system 18 may stream the audio/video file 28 from the local computer system 12 or the streaming server 16. The main server 14 manages the buffer length of the audio/video file 28 depending on the Internet connection speed of the local computer system 12. For instance, if the local computer system 12 has a fast internet connection, the main server 14 may allocate 30 minutes or more of buffer time for the track video 30 and the track audio 32 of the audio/video file 28. Slower connections, like 56 k dial-up, may receive only a few minutes or even 30 seconds of buffer time from the main server 14.

In another embodiment of the present invention, the local computer system 12 begins playback of a media file that was just released by the streaming server 16. The local computer system 12 must first stream the data from the streaming server 16 and write the data to the audio/video file 28. Any buffer regulated by the main server 14 is stored in the track video 30 and the track audio 32 in the audio/video file 28. The local computer system 12 reads the track video 30 and the track audio 32 and transmits that media data to the CODEC 26 for decompression. After decompression, the media is played through the audio/video player 24. Once enough information is stored in the audio/video file 28, the receiving computer system 18 can start streaming the media file from the local computer system 12. Consider, however, that the end-user of the receiving computer system 18 changes the playback time segment in the media file (e.g., the end-user starts viewing 45 seconds into the media file). The receiving computer system 18 communicates with the main server 14 to acquire a list of client computers that have the time segment media file information stored in the audio/video file 28 and available for streaming. Since this is a new file, the receiving computer system 18 receives instructions from the main server 14 to disconnect from the local computer system 12 (as the local computer system 12 no longer has media data information corresponding to the requested time segment) and to reconnect the stream with the streaming server 16 (or any other of the series of computers systems 22 having the required media data for the requested time segment stored thereon).

Another aspect of the present invention is that the P2P architecture 10 incorporates true streaming technology. That is, the local computer system 12 does not have to download any portion of the media file before playback begins. By configuring each media file based on time, the user of the local computer system 12 can request specific media data information with regard to a specific time segment. Playback through the audio/video player 24 is therefore faster than progressive download. This allows a user to rewind, pause, and fast forward through the audio/video file 28 quickly and easily without buffering delays.

All the information streamed throughout the P2P architecture 10 is compressed to enable faster transfer across the corresponding protocol. Compressed data also requires less storage space in the audio/video file 28. Encoded information is decoded by the CODEC 26 before playback through the audio/video player 24. In turn, the CODEC 26 and P2P streaming technology enhance the transmission rate of media data. More information transferred per second translates into higher quality streams, including the possibility of streaming high definition and DVD quality audio and video.

In a particularly preferred embodiment of the present invention, there are four servers regulated by the P2P network administrator. First, the main server 14 regulates the computer systems within the P2P architecture 10. The main server 14 regulates access to the P2P architecture 10 and facilitates distribution of data as previously described. A second server optimizes the P2P architecture 10 such that time segments are routed through the most efficient channels. A third server is the streaming server 16, which performs the functions as previously described. Lastly, the fourth server monitors user behavior to strategically place advertisements within the audio/video player 24 during playback.

More specifically, the fourth server includes the functionality of strategically placing advertisements based on the information displayed in the audio/video player 24. Metadata related to advertisements are also time based. Metadata associated with the time within the audio/video file 28 determines what advertisements are shown on the screen as the end-user plays the media file through the audio/video player 24. For example, if the local computer system 12 is streaming a movie through the audio/video player 24 that is showing a baseball game, the fourth server is capable of recognizing this time segment within that movie and will deliver a baseball related advertisement (e.g., baseball team merchandise, sports drink, sports clinic, etc.). Additionally, the media played through the audio/video player 24 can be interactive. In one embodiment, end-users may rate the entire media or rate specific scenes and insert comments at specific time segments for other end-users to view during subsequent download and playback. Additionally, actual advertisements within the media file itself are changeable by the fourth server within P2P architecture 10. For example, a billboard within a video file is selectively changed by the fourth server to display an advertisement catering to the interests of the end-user. The server processes this information and places advertisements based on viewing history and preference. It is also conceived that other items within the media file can also be regulated and changed, such as clothing content, merchandise, persons, faces, cars, etc. Additional dubbing features such as voice-over dubbing, language dubbing, or audio impaired dubbing is also capable of being written as part of the metadata within the track video 30 and the track audio 32. During playback through the audio/video player 24 the dubbing is synced by the local computer system 12.

Although an embodiment has been described in some detail for purposes of illustration, various modifications may be made without departing from the scope and spirit of the invention. Accordingly, the invention is not to be limited, except as by the appended claims.

What is claimed is:

1. A process for streaming media data in a peer-to-peer network, comprising the steps of:
submitting a request through the peer-to-peer network to play a time segment of a media file;
connecting a local computer through the peer-to-peer network to a streaming computer having the time segment;
locating an initial data byte in the time segment via a conversion table associated with the media file;
streaming the time segment from the streaming computer to the local computer, starting with the initial data byte; and
storing the time segment on the local computer for playback through a media player.

2. The process of claim 1, wherein the streaming step includes the step of streaming subsequent time segments during playback.

3. The process of claim 1, wherein the time segment comprises a portion of the media file.

4. The process of claim 1, wherein the conversion table includes a data byte-to-time segment conversion and a time segment-to-data byte conversion.

5. The process of claim 1, wherein the storing step includes the step of storing non-sequential time segments of the media file on the local computer.

6. The process of claim 1, including the step of buffering the streaming media file by storing subsequent time segments on the local computer, wherein a faster transfer speed corresponds to a larger buffer of time segments.

7. The process of claim 1, including the step of writing the time segment to an audio/video file on the local computer, the audio/video file comprising a track file and a hint track file.

8. The process of claim 7, including the step of storing the conversion table in the hint track file.

9. The process of claim 7, wherein the track file comprises a track audio file and a track video file and the hint track file comprises a hint track audio file and a hint track video file.

10. The process of claim 1, including the step of maintaining a real-time catalog of the media files and the corresponding time segments stored on the computers connected to the peer-to-peer network.

11. The process of claim 1, including the step of changing the requested time segment by rewinding, skipping or fast forwarding through the media file.

12. The process of claim 1, including the steps of compressing and decompressing data streamed through the peer-to-peer network.

13. The process of claim 1, including the step of playing the media file with the media player starting with the initial data byte corresponding to the requested time segment.

14. The process of claim 1, including the step of monitoring upload capability, download capability, data transfer efficiency, distance, latency, IP address, physical location or transfer statistics of the computers connected to the peer-to-peer network.

15. The process of claim 14, including the steps of regulating and optimizing data transfer among the computers connected to the peer-to-peer network based on information gathered in the monitoring step.

16. The process of claim 1, including the steps of introducing a new media file to the peer-to-peer network via a server managed by a system administrator and preventing unauthorized introduction of the new media file to the peer-to-peer network with a digital rights management technology.

17. The process of claim 1, including the step of introducing a new media file to the peer-to-peer network via a peer computer.

18. The process of claim 1, wherein the peer-to-peer network transfers data via a transmission control protocol, a user datagram protocol, a reliable user datagram protocol, a real-time transfer protocol, a real-time messaging protocol, a real-time streaming protocol or a hypertext transfer protocol.

19. The process of claim 1, including the step of embedding metadata in the media file.

20. The process of claim 19, including the step of writing an advertisement or a comment to the metadata.

21. The process of claim 20, including the step of conveying the advertisement or the comment during playback.

22. The process of claim 1, including the step of substituting products, people or languages with other products, people or languages during playback of the media file.

23. A process for streaming media data in a peer-to-peer network, comprising the steps of:
submitting a request through the peer-to-peer network to play a time segment of a media file;
maintaining a real-time catalog of the media files and the corresponding time segments stored on the computers connected to the peer-to-peer network;
connecting a local computer through the peer-to-peer network to a streaming computer having the time segment;
locating an initial data byte in the time segment via a conversion table associated with the media file, wherein the conversion table includes a data byte-to-time segment conversion and a time segment-to-data byte conversion;
streaming the time segment from the streaming computer to the local computer, starting with the initial data byte;
storing the time segment on the local computer for playback through a media player;
writing the time segment to an audio/video file on the local computer, the audio/video file comprising a track file and a hint track file; and
buffering the streaming media file by storing subsequent time segments on the local computer.

24. The process of claim 23, wherein the streaming step includes the step of streaming subsequent time segments during playback, wherein the time segment comprises a portion of the media file.

25. The process of claim 23, wherein the storing step includes the step of storing non-sequential time segments of the media file on the local computer.

26. The process of claim 23, including the step of storing the conversion table in the hint track file.

27. The process of claim 23, wherein the track file comprises a track audio file and a track video file and the hint track file comprises a hint track audio file and a hint track video file.

28. The process of claim 23, including the step of changing the requested time segment by rewinding, skipping or fast forwarding through the media file.

29. The process of claim 23, including the steps of compressing and decompressing data streamed through the peer-to-peer network.

30. The process of claim 23, including the step of playing the media file with the media player starting with the initial data byte corresponding to the requested time segment.

31. The process of claim 23, including the steps of regulating and optimizing data transfer by monitoring upload capability, download capability, data transfer efficiency, distance, latency, IP address, physical location or transfer statistics of the computers connected to the peer-to-peer network.

32. The process of claim 23, including the steps of introducing a new media file to the peer-to-peer network via a server managed by a system administrator and preventing unauthorized introduction of the new media file to the peer-to-peer network with a digital rights management technology.

33. The process of claim 23, wherein the peer-to-peer network transfers data via a transmission control protocol, a user datagram protocol, a reliable user datagram protocol, a real-time transfer protocol, a real-time messaging protocol, a real-time streaming protocol or a hypertext transfer protocol.

34. The process of claim 23, including the steps of writing an advertisement or a comment to metadata in the media file and conveying the advertisement or the comment during playback.

35. The process of claim 23, including the step of substituting products, people or languages with other products, people or languages during playback of the media file.

36. A process for streaming media data in a peer-to-peer network, comprising the steps of:
submitting a request through the peer-to-peer network to play a time segment of a media file;
maintaining a real-time catalog of the media files and the corresponding time segments stored on the computers connected to the peer-to-peer network;
regulating and optimizing data transfer by monitoring upload capability, download capability, data transfer efficiency, distance, latency, IP address, physical location or transfer statistics of the computers connected to the peer-to-peer network;
connecting a local computer through the peer-to-peer network to a streaming computer having the time segment;
locating an initial data byte in the time segment via a conversion table associated with the media file, wherein the conversion table includes a data byte-to-time segment conversion and a time segment-to-data byte conversion;
streaming the time segment from the streaming computer to the local computer, starting with the initial data byte, wherein the time segment comprises a portion of the media file;
storing the time segment on the local computer for playback through a media player;
writing the time segment to an audio/video file on the local computer, the audio/video file comprising a track file having a track audio file and a track video file and a hint track file having a hint track audio file and a hint track video file, wherein the conversion table is stored in the hint track file;
buffering the streaming media file by storing subsequent time segments on the local computer, wherein a faster transfer speed corresponds to a larger buffer of time segments;
changing the requested time segment by rewinding, skipping or fast forwarding through the media file; and
playing the media file with the media player starting with the initial data byte corresponding to the requested time segment.

37. The process of claim 36, wherein the storing step includes the step of storing non-sequential time segments of the media file on the local computer.

38. The process of claim 36, including the steps of compressing and decompressing data streamed through the peer-to-peer network.

39. The process of claim 36, including the steps of introducing a new media file to the peer-to-peer network via a server managed by a system administrator and preventing unauthorized introduction of the new media file to the peer-to-peer network with a digital rights management technology, wherein the peer-to-peer network transfers data via a transmission control protocol, a user datagram protocol, a reliable user datagram protocol, a real-time transfer protocol, a real-time messaging protocol, a real-time streaming protocol or a hypertext transfer protocol.

40. The process of claim 36, including the steps of writing an advertisement or a comment to metadata in the media file and conveying the advertisement or the comment during playback, wherein the metadata further includes information for substituting products, people or languages with other products, people or languages during playback of the media file.
